(19) United States
(12) Patent Application Publication
(10) Pub. No.: US 2021/0118029 A1
(43) Pub. Date: Apr. 22, 2021

(54) GEOLOCATION SPECIFIED INTEGRATED SHOPPER, STORE AND PERSONAL SHOPPER DELIVERY SHOPPING ECOSYSTEM

(71) Applicant: Srirajasekhar Koritala, Naperville, IL (US)

(72) Inventor: Srirajasekhar Koritala, Naperville, IL (US)

(21) Appl. No.: 16/658,125

(22) Filed: Oct. 20, 2019

(51) Int. Cl. G06Q 30/06; G06Q 20/32; G06Q 10/08; H04W 12/06

(52) U.S. Cl. CPC G06Q 30/0617; G06Q 30/0641; G06Q 30/0627; G06Q 30/0639; G06Q 30/0282; G06Q 10/08345; G06Q 10/0833; H04W 12/0608; G06Q 20/3223

(57) ABSTRACT

Samyata ecosystem provides a new and efficient retail commerce platform and ecosystem to bring stores, shoppers and personal shoppers together in a geographical area.

### BACKGROUND

### Field of the Invention

This invention relates to E Commerce and more particularly relates to Geo Specific online shopping and delivery service.

### Related Art

There are many popular e-commerce applications like Amazon, Flipkart and shopify which are helping the customers for their research, compare prices, and manage their Account. There are also different types of e commerce applications using geo location for providing services But none of them are providing a common platform for bringing stores, shoppers and personal shoppers in a geographically specific location.

Samyata ecosystem gracefully addressed the problem of integrating stores, shoppers and personal shoppers together in a specific geographic location.

Prior Art did not provide a common platform for the shoppers, stores and personal shoppers in a specific geographical location

Prior Art did not provide Personal Shopper delivery services to all the users along with other delivery options like pick up from the store and shipping

Prior Art did not let shoppers to choose their own delivery rate for Personal Shopper delivery services.

Prior Art did not provide store specific loyalty programs for the stores enrolled in the system

Prior Art did not let the Personal Shopper to choose their own rate for making deliveries.

Prior art does not allow a shopper to buy locally and have three ways to get the product through pickup at the store, personal shopper pickup and shipping

Prior art does not let connect nearby personal shoppers with shoppers for the purposes of buying and delivering their purchases.

This problem was not addressed. No system does the geolocation specific finding of products and integrated delivery through pickup, personal shopper or shipping. Most ecommerce system are specific to a single brand of stores or require the purchase to be shipped. Current systems cannot provide an integrated solution that allows a shopper to find the product they would like to purchase in a store near them, purchase the product through the system at the store of choice and then deliver the product through either pickup, personal shopper or shipping at the store.

### SUMMARY OF INVENTION

The present invention is an ecosystem called Samyata which brings the shoppers, stores and Personal Shoppers in a specific geographical location to a common platform. Samyata Eco System consists of a shopper application called Samyata. Seller Application called Samyata Store, Personal Shopper Application called Samyata Personal Shopper and also has its own proprietary payment system.

Moreover, it's the only interface where an individual can act as a shopper and earn money as a Personal Shopper.

### BRIEF DESCRIPTION OF THE FIGURES

FIG. 1 is a flowchart illustrating a method for online shopping platform to bring stores, shoppers and personal shoppers together in a geographically specific, simple buying and selling experience.

FIG. 2 is a flowchart (front end) showing a common platform for all the shoppers, stores and personal biographers in a specific geographical location and also shows the flow how each application is connected to one another.

Embodiments of the present disclosure and their advantages are best understood by referring to the detailed description that follows. It should be appreciated that like reference numerals are used to identify like elements illustrated in one or more of the figures, wherein showings therein are for the purpose of illustrating embodiments of the present disclosure and not for purposes of limiting the same.

### DETAILED DESCRIPTION

The present invention provides a unique and integrated platform for all the shoppers, stores and personal shopper in a specific geographical location.

It's the only interface where an individual can act as a shopper and earn money as a Personal Shopper.

The present invention is an online shopping interface which helps in buying the user desired products from nearby stores. Saving the user from the trouble of searching the products in many stores, not knowing if they actually have the desired product in their inventory. Price comparison is no more hassle through the present system. User can receive the product in anyway they want it. This invention provides various delivery options which includes Picking from the store, shipping and geolocation specific personal shopper. Pay for it anyway you want either through proprietary payment system balance, debit or credit card or ACH or Apple Pay.

The present invention is only the application providing shopping interface, Providing it's own delivery method through personal Shopper.

Saving Time: Samyata shopping app resolve the problem of searching for a product in multiple stores nearby, not knowing if they actually have the desired product in their inventory.

Familiarity of nearby stores: Any stores enrolled in Samyata can improve their reach especially among local people

Connecting with Targeted audience: The present invention helps the stores to connect with targeted audience and get the benefits of localization. Also, stores can gather valuable data about their customers' behavior and make the marketing plan on that basis.

Price Comparison: The present invention provides reliable information where shopper can find the stores near by which carries the desired product and also can compare prices at different stores carrying the same product on a common platform.

Set your own rate approach: The present invention gracefully addressed the problem of setting delivery prices to the satisfaction of shoppers and Personal Shoppers with the concept of set your own rate.

Loyalty Program: None of the applications provide loyalty Programs for the stores especially local stores enrolled in a system. The present invention is providing the store special loyalty programs for retaining loyal customers for all the enrolled stores.

Being an e-Commerce app integrating location based features helps the shopper to determine the time to get that product from nearby stores and also can make purchasing decisions considering many factors based on convenience.

The present invention offers different mode of delivery options which includes pick up, Shipping, and more personalised mode of delivery through Personal Shopper.

Choosing personal shopper mode of shipment allows user to schedule delivery at their convenient timings. So, there is a least chance of missing the package scheduled for drop.

Choosing personal shopper also help to avoid delivery hours overlap with most weekday jobs. It is very hard to present at home when the package is scheduled for delivery. Taking advantage of the scenario other shipping services charges extra fee in order to deliver the weekends. Choosing Personal Shopper delivery solves this problem by not charging any extra fee for weekend deliveries.

You can schedule Personal Shopper to deliver your product with in few hours from placing the order.

Personalisation: Having Personal Shopper mode of delivery give scope for personalisation. You the choice to pick a personal shopper at desired rating and can schedule delivery at any time within 24 hours.

Reliability: Having personal Shopper mode of shipment is highly reliable as they Provide exact delivery date and time.

No minimum order requirement: You can order any priced product and can select personal shopper mode of shipment to receive it.

Main objective of the present invention is to provide the best user experience ever. The present invention considered each and every element like Quality, performance, stability, security and reliability in order to achieve the objective.

Lot of precautionary steps were taken to ensure high quality of the present invention method/system. We made sure to meet all the guidelines and specifications set by Android and IOS in each and every phase of development life cycle.

The present invention provides an unique and integrated platform for all the shoppers, stores and personal shopper in a specific geographical location. All these three different applications are combined to get a unique shopping experience with these three independent features functioning together to give a combined result. The whole application is called as Samyata Application which has these three applications are discussed hereunder.

I. Samyata: It's an online shopping interface which helps shoppers to find and buy their desired products from the stores in a specific geographical location. Using Samyata shopping app resolve the problem of searching for a product in multiple stores nearby, not knowing if they actually have the desired product in their inventory. Price comparison is no more a hassle in Samyata. You can receive the product in anyway you want it. Samyata provides various delivery options which includes Picking and geolocation specific personal shopper. Pay anyway you want either through debit or credit card or ACH or Apple Pay in the proprietary payment system of Samyata.

II. Samyata Store: One can expand their business reach by listing their products in Samyata Store which can be sold via Samyata Application. One can create their own store and manage their store specific inventory. Store people can manage their revenue and staff using the application.

III. Samyata Personal Shopper: This application is a part of Samyata EcoSystem. Personal Shoppers in a specific geographical location can signup and deliver the orders of Samyata. Personal Shoppers can choose to deliver at their convenient timings and also choose to accept or deny the order. They can manage their earnings received through the Samyata.

All the apps in Samyata Ecosystem are provided with consistent cross platform proprietary payment interface. This is integrated with almost all the applications of Bodaty.

There are are many unique elements in Samyata Application.

1. Algorithm for product search.

2. Algorithm for assignment of personal shoppers in product delivery results—which personal shoppers get displayed as having a product for a shopper

3. The auto-rotate bar for product images

4. Samyata Now

5. Samyata Gives

6. Samyata Loyalty

7. Samyata Conversational UI

8. Your own Personal Shopping Network

### 1. Algorithm For Product Search:

Samyata Product Search algorithm is realised with a cloud database and some cloud functions. With this algorithm one does not need to download the whole database of products into the mobile end. Once a product is searched the search will be saved in a collection in the database. When other people make the same search the results will just be loaded without any additional calculation based on the ranking.

Algorithm for prioritization of stores in product search results—which stores get displayed as having a product for a shopper.

2. Algorithm for Assignment of Personal Shoppers in Product Delivery Results—which Personal Shoppers get Displayed as having a Product for a Shopper:

Algorithm lets the assignment of nearby personal shoppers in product delivery results to the shoppers.

Geolocation specific personal shopper provides more personalised way of delivery services. Shoppers can schedule delivery at their convenient timings. They can also choose to receive the product from few hours of ordering it. Live tracking is available which enables the shopper to track the personal shopper. Shopper can choose desired rating personal shopper.

### 3. The Auto-Rotate Bar for Product Images:

Samyata is an online shopping interface which helps in buying your desired products from nearby stores. Samyata implemented Auto Rotation bar for displaying all available images of the product in the form of Slideshow, Without tapping on each tab for viewing the product from various angles.

### 4. Samyata Now:

To personalize the user's shopping experience Samyata have launched a special service called Samyata Now.

You can use Samyata Now to have a personal shopper bring you literally anything! Samyata Now provides a personalized experience between you and a personal shopper. Communicate directly with them during the entire buying process and have them find exactly what you're looking for.

Personal Shopper brings the product from the Samyata Store or Non-Samyata Store based on product availability. Not only the big spenders but also all the shoppers of Samyata gets benefited by this service at a reasonable cost.

### 5. Samyata Gives:

Samyata Gives will be a program through the Samyata app that allows users of the Samyata app to buy products at select stores, while also supporting local charities. The charities can sign up through a separate app and will be put into the samyata database that will allow stores to choose which charity or charities they want to support. When people shop at these stores through the Samyata app, a certain percentage of the sale will be automatically donated to the specified charity. This will work similar to Amazon Smiles, but instead of having to shop through a special link, it will be directly integrated into the app.

### 6. Samyata Loyalty:

This feature is added to Samyata ecosystem to provide loyalty program for all the Samyata local stores. This concept aim is to encourage customers to continue to shop at the same Samyata Store repetitively. Most of the big brands have this stuff, but none of the local stores have this in place.

There are many big companies having their own loyalty programs where their phone number is collected and points are added to the shopper's account, but none of the local stores have this feature. Because it's very expensive to build and maintain one. Samyata made it affordable for all the local stores through this feature.

### 7. Samyata Conversational UI:

Everyone knows how important is the user experience these days. A very huge part of the user experience is the interface that sits between a user and a service. In an attempt to provide better user experience Bodaty came up with an interesting concept called Samyata Conversational UI.

Samyata Conversational UI provides an interface where shoppers can chat with the BOT and buy the product effortlessly.

Unique features of Samyata Conversational UI:

Samyata Conversational UI is built using cutting edge technologies like Dialogue Flow AI BOT. Shoppers can buy the product automatically by interacting with AI BOT. User can shop for the products without going through multiple pages

8. Set your Own Rate:

Setting rates for personal shoppers and figuring out how much shoppers are willing to pay for personal shoppers have been difficult. Based on all the research there have been several issues that we have noticed and these include—

Personal shoppers want more pay

Shoppers don't want to pay as much

So setting a rate that meets both constituents needs has been hard

Most pricing formulas in the market are complicated and confusing

Most companies are losing money by setting rates that don't make sense

To solve this issue we will now follow a “set your own rate” approach using a “you control what you pay/earn” (pay for shoppers, earn for personal shoppers) philosophy. We will let personal shoppers set their own delivery rates and parameters and we will let shoppers choose what they want to pay for personal shopping, and we will provide the means to match the two sides—thus satisfying both personal shoppers and shoppers. The added advantage is that there is no need for tipping now because the agreed-upon rate includes everything—thus greatly simplifying the process for both sides. We still keep the ratings and the ability of shoppers to choose favorite personal shoppers as such.

In an example, a shopper may use the Samyata Application via a user device to buy winter clothes these (e.g., sweater, boots, a ski jacket, etc.,), winter sporting goods (e.g., skis, goggles, etc.,), and winter car equipment (e.g., an ice scrapper, snow tire chains, etc.) for a ski trip. The user may go to Samyata application and open online shopping interface which helps shoppers to find and buy their desired products from the stores in a specific geographical location. Shopper may chose to let the assignment of nearby personal shoppers in product delivery results to the shoppers. By this, geolocation specific personal shopper provides more personalised way of delivery services with a scheduled delivery at their convenient timings with live tracking. The shopper may also auto rotate bar for displaying all available images of the product in the form of slideshow while shopping through Samyata Application. Also, shopper can establish a personal communication with the shop to complete the buying process and also to find exactly what shopper is looking for. Through smayata application shoppers can make charity givings. Shoppers may also earn loyalty program offers offered by different stores. Shoppers may chat with the BOT and buy the product effortlessly. And finally shoppers may also set their own delivery rates for receiving deliveries made through Personal Shopper. With the unique features embedded in the Samyata System, the shopper will have a new experience with comfort and ease of shopping online.

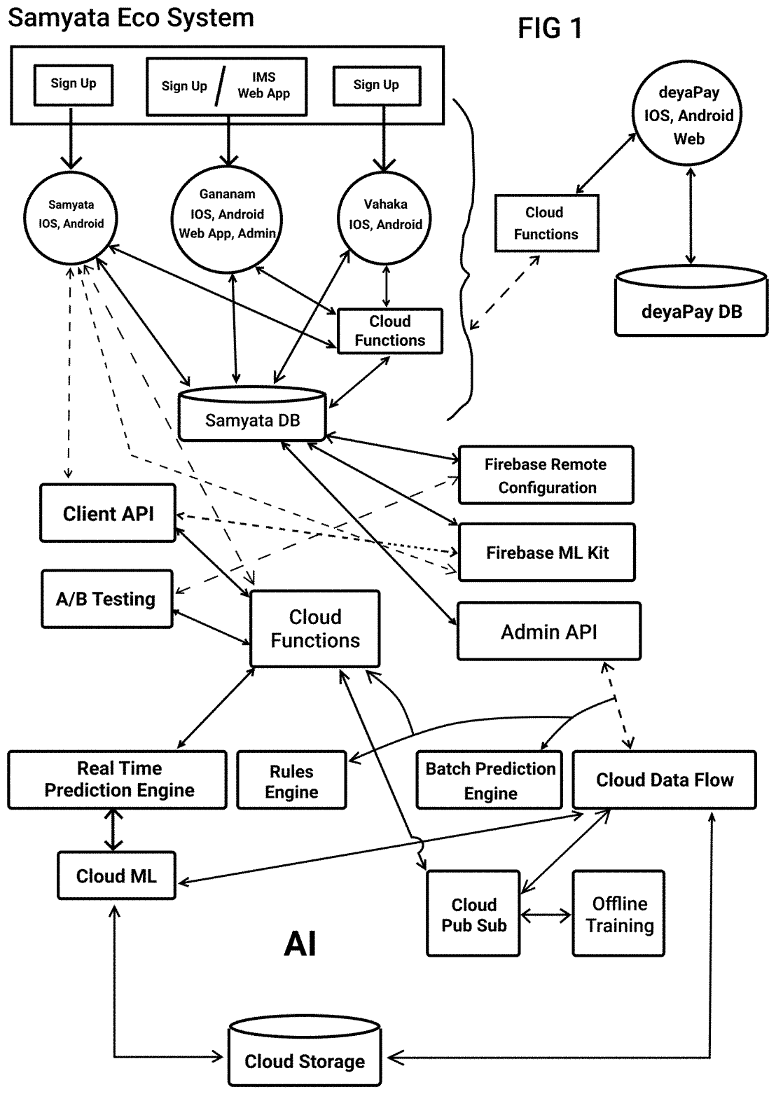

Referring now to FIG. 1, a method for online shopping platform to bring stores, shoppers and personal shoppers together in a geographically specific, simple buying and selling experience contains three parts to the architecture of Samyata Application:
1. Samyata Operational Flow—
   The operational flow is where most of the processing for the Samyata Retail system happens. This includes the various apps, web apps, and admin web apps and the database that constitute the system.
1. Samyata AI/Deep/Machine Learning—
   Over time the Samyata system accumulates data about several operations in the Samyata system. This data is then analyzed to provide various smart and predictive functions that benefit all users.
1. DeyaPay Payment Processing—
   All of the payment processing and account management for Samyata is provided through deyaPay payment processing.

### Samyata Operational Flow

The operational flow is where most of the processing for the Samyata Retail system happens. This includes the various apps, web apps, and admin web apps and the database that constitute the system.

There are four layers to the Samyata operational flow including—
1. UI Layer
   The UI Layer includes the mobile apps (iOS and Android), web apps, admin web apps, and websites. The websites generally provide access to signing up for the Samyata system as either a shopper, personal shopper or store, depending on which website is accessed in the system. The signup information is collected through a webform and sent to the application layer where the enrollment and recording of the enrollment and necessary verifications happen with the data layer and the confirmation of success or failure is sent back to the UI layer (the website).

The mobile apps are the core of the Samyata interaction model with the users. There are separate mobile apps for the store, shopper and personal shopper which provide all the functionality to the users.

In the case of the Samyata Store, there is also a web application that provides the same functionality as the mobile app and other inventory management functionality to manage the store.

The admin apps are available only to the Bodaty administrators who manage various aspects of the system through these web apps.

### 1. Application Layer

The application layer is the code that implements most of the functional logic in the various apps and web apps.

All of these mobile and web apps present the functionality in an intuitive manner to the user, collect the necessary inputs and work with the application layer code to interact with the data layer and provide the necessary functionality. Data and application logic responses flow back and forth between the various apps and the data layer.

### 1. Data Layer

The data layer is the database and the schema that represents and stores the data relevant to the functioning of the Samyata system.

### 1. API Layer

The API layer is the part of the code that interacts with and calls various APIs that provide specific functionality for the Samyata system externally. IN order to accomplish various specific tasks such as payments, tax calculations, shipping calculations, and other such specific functionalities the application layer will work with the API layer to call various APIs outside of the Samyata system to obtain this information.

Samyata AI/Deep/Machine Learning (ML Model)

Over time the Samyata system accumulates data about several operations in the Samyata system. This data is then analyzed to provide various smart and predictive functions that benefit all users.

Most of the interactions between the Samyata operational model and the ML model typically happen through APIs such as the Firebase Admin, ML Kit, and Remote configuration APIs. The data is fed from the operational system and fed into the ML model for various tasks like model construction, testing, and validation. This is done through the cloud data flow and this data is anonymized and stored in the cloud data storage for model management. This data is then fed through the cloud ML API to create and train ML models and provide real time, rules-based and batch predictions which are used to provide smart functionality to users in the Samyata system.

Payment Processing

All of the payment processing and account management for Samyata is provided through it's own payment processing interface. The application layer of the Samyata operational model calls into the deyaPay system through a cloud function-based API layer to perform various payment functionalities. These include processing payments through various payment methods, providing access to user accounts and transaction histories and splitting or sharing purchases with others.

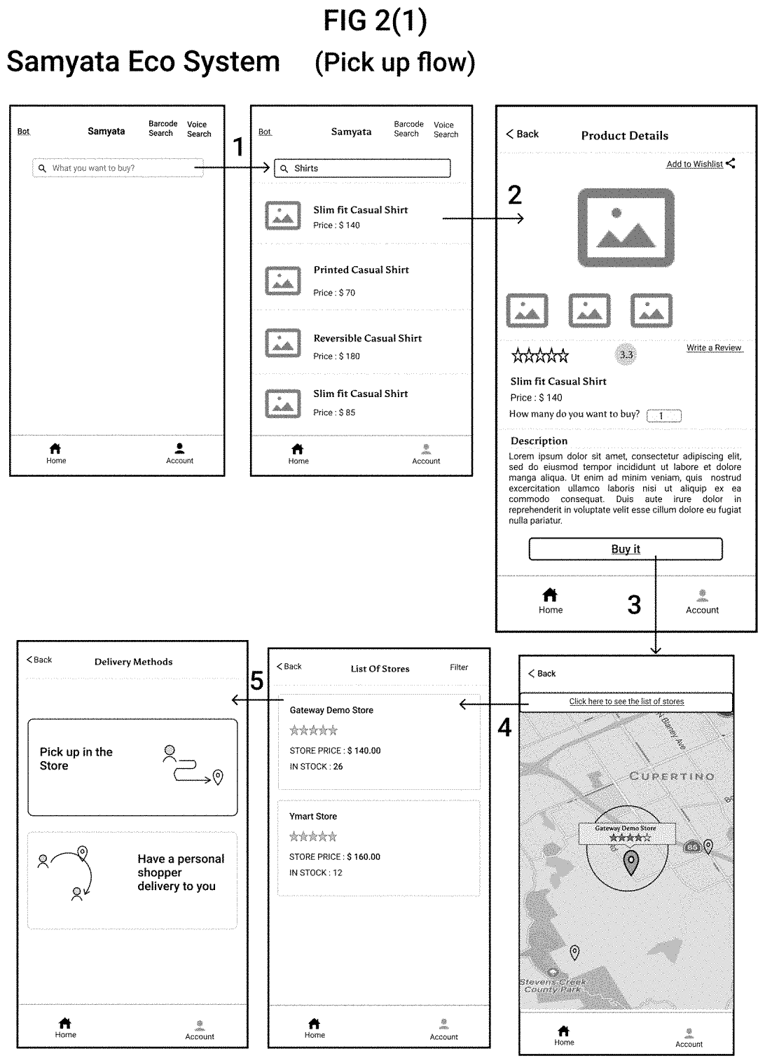

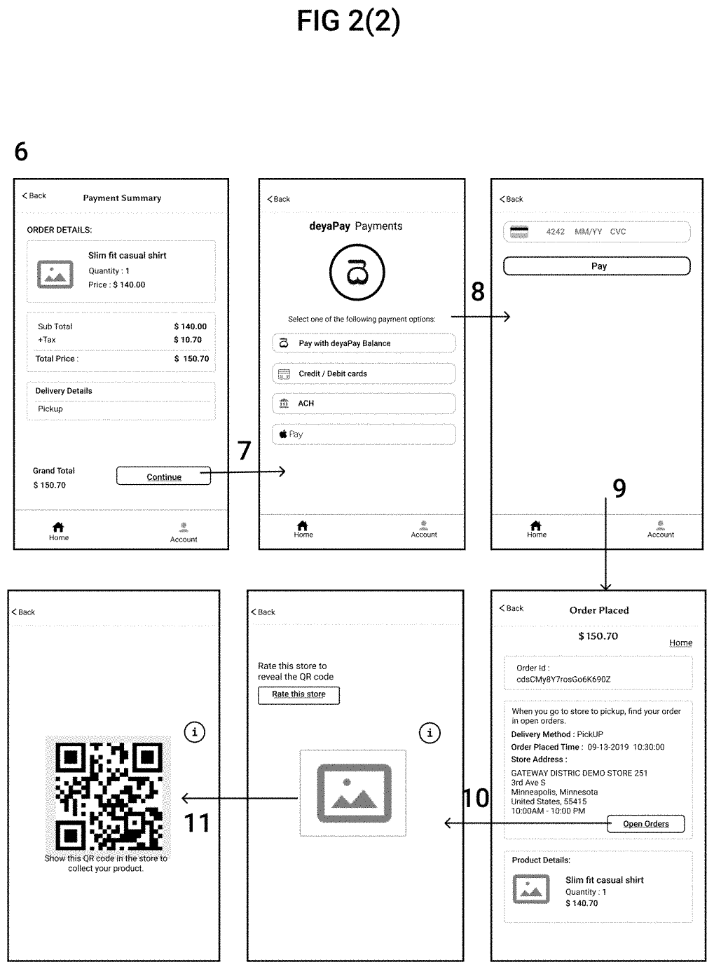

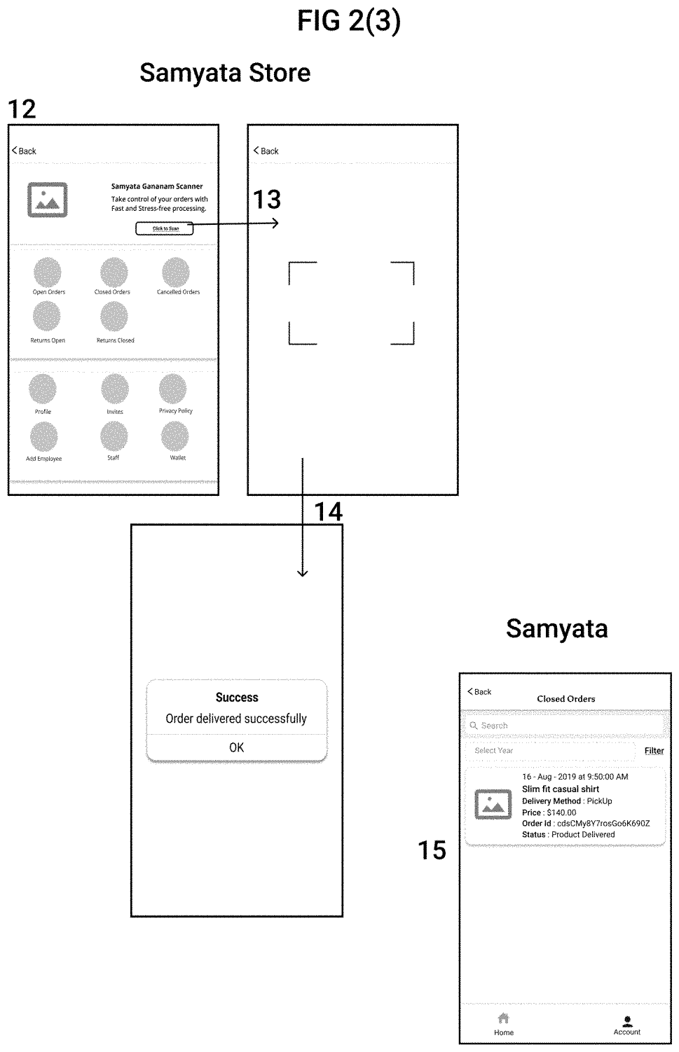

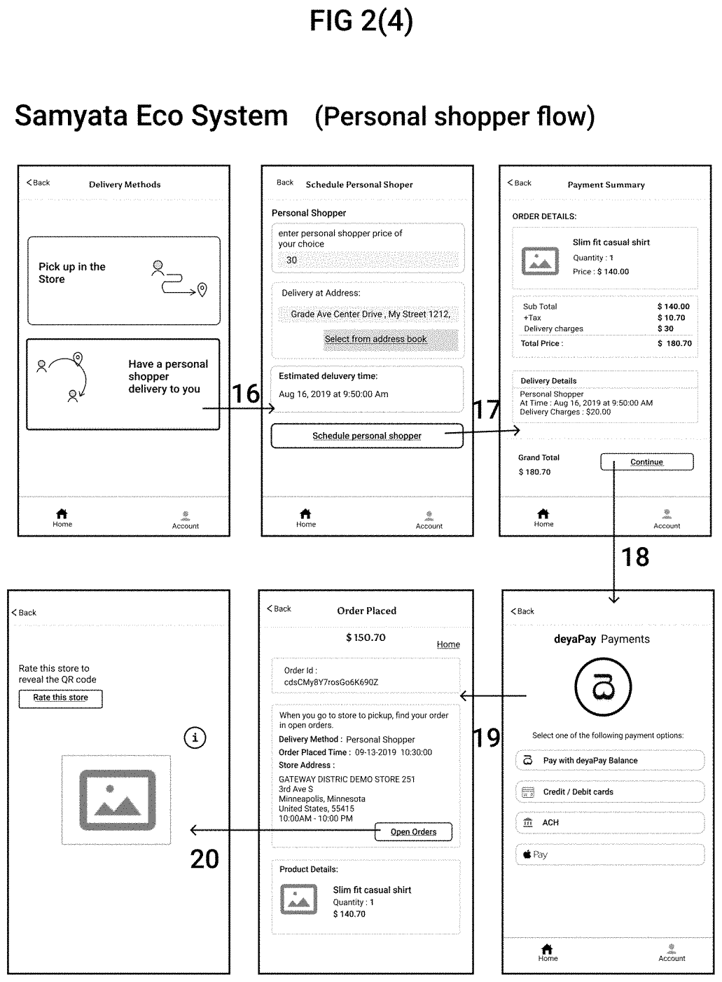

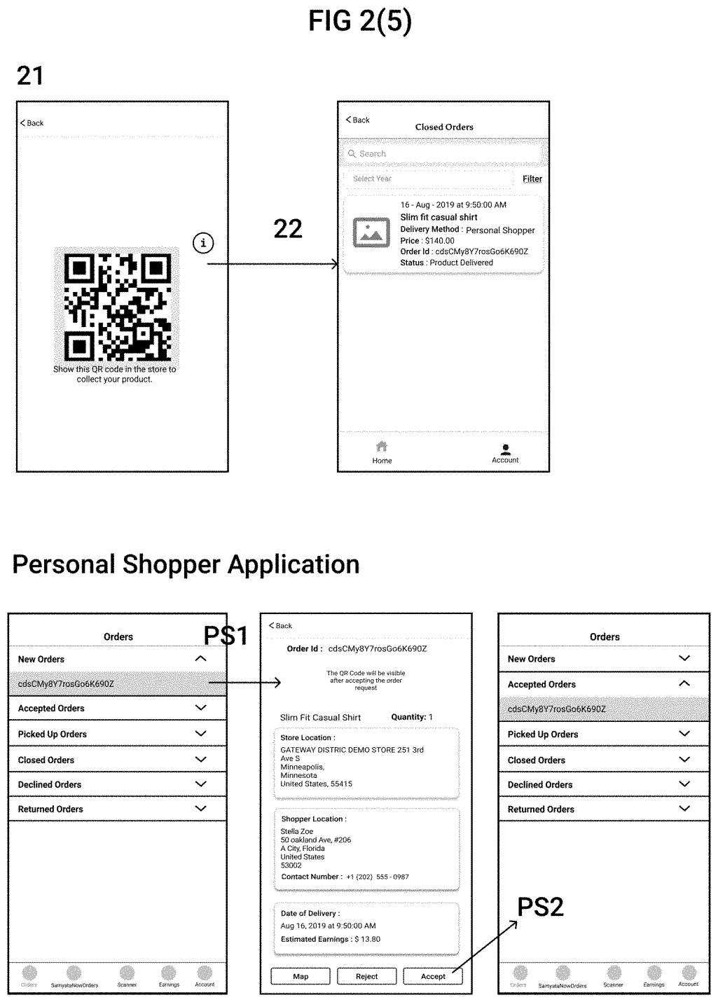

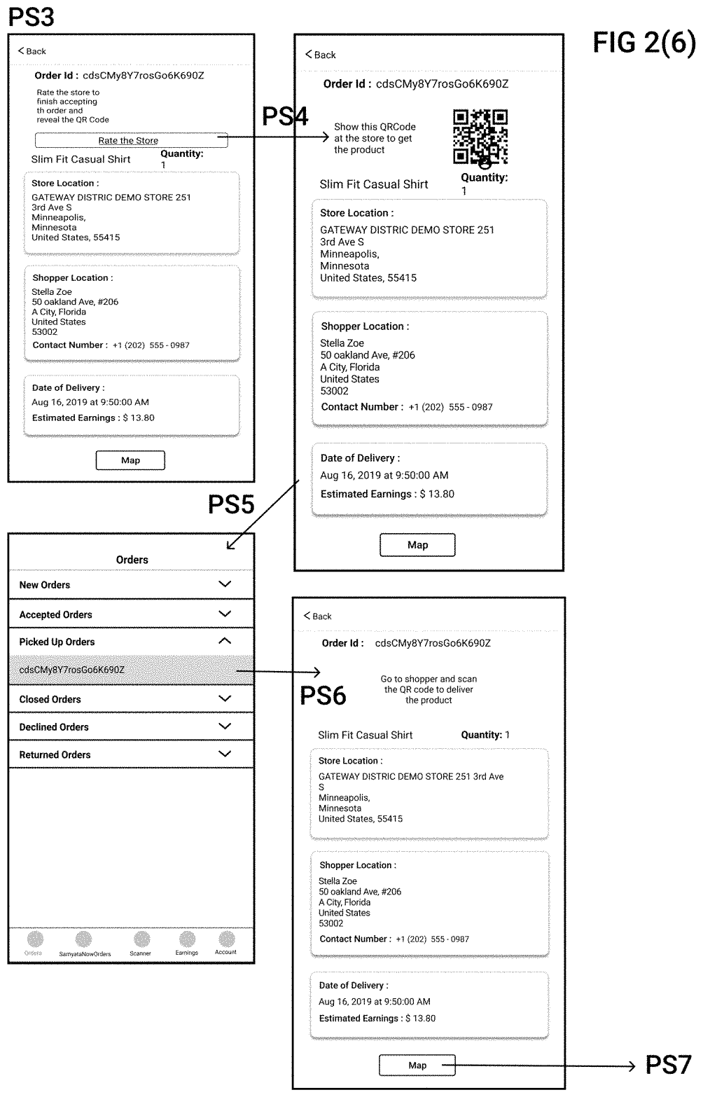

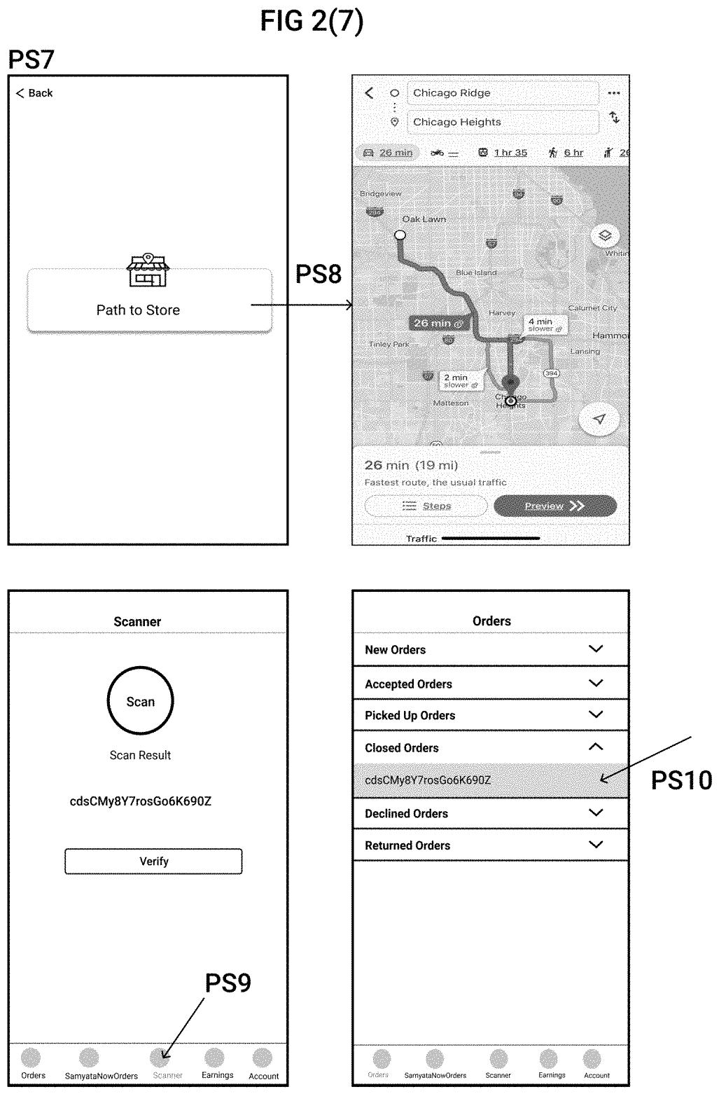

Further to understand the Samyata Ecosystem Flow (Front End), refer to FIG. 2 which shows how Samyata is providing a common platform for all the shoppers, Stores and Personal Biographers in a specific geographical location and also shows the flow how each application is connected to one another.

Authentication Screen:

Authentication in Samyata is through the phone, please ensure that you choose the right country code (default pre-selected is +1 for the US). Then enter your 10 digit phone number with no spaces or special characters etc. Also, phone cannot be on the airplane mode etc. Your phone needs to have access to a cellular phone network in order to receive the OTP through SMS. Enter the OTP that is sent to your mobile number and tap verify. If you are new user set your password which can be used for logging into all the Samyata ecosystem applications (Samyata, Samyata Store and Samyata Personal Shopper).

Samyata Home Page: Once Samyata registration is successful, the user will be taken to the homepage of Samyata where user can search the product in three different ways and buy it.
1. Manual Search
2. Voice Search
3. Barcode Search

Manually Searching the Product: User can search for the product by giving a search string, all the relevant products matching the string will be displayed.

Searching the product using Barcode: One can search for the product by scanning the barcode. The products whose barcode exists in Samyata ecosystem will appear in the search results.

Searching for a product through voice: The shopper can input his/her voice for searching the product.

Product Details Page: This page displays all the details of the selected product and user can choose the quantity he wants to buy and will be taken to the map page by clicking on the buy it option.

Geo Location Page: User can select the store by clicking on the store icon in the mapview or he can view all the stores carrying the desired product by selecting the List Of Stores option.

List Of Stores Page: This page displays all the stores carrying the desired products and sorting of the stores is defaulted by price, distance and stock. User can always have an option to sort by price or distance or stock.

Delivery Methods Screen: User will be taken to the Delivery Method Screen after selecting a store. Shopper can choose how they want the product to be delivered. There are two modes of delivery in Samyata 1.Pick Up 2. Personal Shopper.

Payment Summary Page: Once user selects pick up option, he will be taken to the Payments Summary Page.

Payments Page: Clicking on Continue takes the user to our proprietary payment interface. User can choose any payment method to pay with Debit/Credit, proprietary Pay Balance, Apple Pay or ACH and can proceed with payment. Once payment is processed order will be placed successfully.

Now let me tell you how Samyata is connected to Samyata Store and also show you the flow of Samyata Store.

Once order is placed, specific Samyata Store will receive the order and when the shopper comes to pick the product from the Samyata Store. Samyata Store person will use Samyata Scanner feature and scan the QR Code which is under Samyata User Open Orders tab. Order can be delivered only when QR code exactly matches to the QR code of Samyata Store order.

Schedule Personal Shopper Screen: Once the shopper picks Personal Shopper Mode of Delivery, he will be taken to Schedule Personal Shopper screen, shopper can schedule a personal shopper by entering all the required details like how much a shopper is willing to pay for the delivery?

Delivery address and when he wants the product to be delivered which includes date and time. Once all the details are given, he can proceed further by clicking on Schedule Personal Shopper button.

Payment Summary Page: Once user clicks on schedule Personal Shopper button, he will be taken to the Payment summary page from where he can see the Total Price and continue further.

Once Samyata user payment is processed successfully connection of Samyata to Samyata Personal Shopper begins.

Samyata Personal Shopper Flow:

Samyata Personal Shoppers are the Personal Shopper who are enrolled in Samyata for delivering the products shopped by Samyata Users.

Samyata Personal Shopper Home Page:

As soon as the order confirmed, Personal Shopper will get notified.

Order Details Page: Clicking on the order ID under Open Orders tab will take the Personal Shopper to the order details page. In this page Personal Shopper can see all the order details like Store Location, Shopper Location, Date Of Delivery and Time of Delivery. By looking at all these details Personal Shopper can choose to Accept or Deny taking the order.

Once Personal shopper accepts the order, the New Order falls under Accepted Order. Clicking on the Order ID take the user to order details Page. Clicking on the map tab takes the shows the Store Direction to the personal Shopper.

Note: Personal Shopper should rate the store to reveal the QR code.

Personal Shopper after going to the store should rate the store first to reveal the QR code and then Store Person will scan the QR code using the Scanner feature of Samyata Store. Product will be delivered only when QR code of Store people and Personal Shopper exactly match.

Picked Up Order: As soon as the Personal Shopper picks the product from the store, order will move from Accepted Orders to the Picked Up Orders. Clicking on the map show the Direction to the Shopper Location.

Samyata Personal Shopper will go the shopper place and scan the QR code to deliver the product. QR code of Personal Shopper should exactly match with the Shopper's QR code.

Closed Orders: As soon the Shoppers and Personal Shoppers QR code matches, product will be delivered to the shopper and the Order will fall from Picked Up Order to the Closed Order.

Declined Orders: If a Personal Shopper choose not to accept a certain order. It immediately falls under declined orders.

Return Order: If a shopper choose to return a product and also choose a personal shopper to deliver the returns. Shopper can do it and Personal Shopper will receive Return Order Notification and based on all the details Personal Shopper can choose to accept or decline the order.

As soon as the personal Shopper accepts the Return Order immediately order falls under Accepted order and clicking on the map shows the direction to the store and Personal shopper can return the order by scanning the QR code and Returns are accepted by the Store people only when both of their QR codes matches with each other.

By taking an example here the shopping method through the Samyata Application may be described as follows with reference to the FIG. 2 and marked numerals therein.

FIG. 2 flow represents two scenarios
1) Shopping in Samyata by choosing pickup delivery option: This scenario explains how Samyata is bringing together shoppers and Stores in a specific geographical location
2) Shopping in Samyata by choosing Personal Shopper Delivery Option: This scenario explains how Samyata is bringing together shoppers, Stores and Personal Shoppers in a specific geographical location.

Scenario1: Authentication in Samyata application is only through the phone. When a shopper logs into Samyata web application or mobile phone app. He will be opened to Signup Screen where he needs to enter his mobile number. The application server will send an OTP message to the users mobile phone which has to be entered in the next screen and submit verification of the OTP entered. The system will take the user to the next screen where the user is required to set login password, Once password is set shopper will be taken to the Home Page of Samyata (Screen1) In the same screen, shopper has three different search options Voice Search, Manual Search and Barcode Search for searching his desired product to buy screen (1). When the user clicks the search button in the screen (1), another next screen (2) will be opened with the search results (2), where the user can select the product and click to enter into next screen (3) where it shows complete description of the product, its reviews, rating given by previous users and with an option in this screen (3) to click to Buy it. When the user clicks Buy it button, the screen (4) will be opened showing the geographical map of the area where the stores in which the product is available and user can also see the distance between the stores and location from where he accesses. In this screen (4), the user is given to button to click to see the list of stores as per geographical location in the previous screen. Enters into the List Of Stores screen (5) and in the same screen stores appears in the order of stock (high to low) rating (high to low) and pricing (low to high). User can filter the stores by any filtering criteria like stock, price and distance by which the user can take the decision to go with any one of the stores in that geographical location. Upon selecting a store in screen (5) any specific store to purchase, the next screen opens showing the delivery methods options like of pick-up from the store or delivery by a personal shopper. The user can select any option in delivery methods screen and proceed to the next screen (6) showing the payment summary and proceed to the next screen (7) to select the payment method and make the payment in the next screen (8) through ant selected payment method. The application takes the shopper to the next screen (9) showing the order placed. Once order is placed shopper needs to go to the store for picking up the product. Shopper's QR Code need to be shown to the Store Person in order to pick up the product from the store, but this QR code will be only visible when shopper first rates the store. Once Shopper finishes rating the store, QR code will be revealed under Open Orders tab and shopper will receive the product from the store if QR code from the store matches to the shoppers QR code.

Samyata Store People will use scanner feature in Samyata Store app to scan the QR code with the Shopper. So, product will be delivered to the shopper only when both shopper and stores QR code matches with one another.

Scenario 2:

The Samyata application has a specific further experience where the user in screen (16) after selecting the delivery method by the personal shopper option, the screen moves and opens another screen (17) to schedule a personal shopper selection button and also shopper can enter the delivery price of his choice which means the shopper can enter how much he is willing to pay for personal shopper delivery. Shopper can choose any of his favorite personal shopper to deliver the product. When shopper finish entering the price and scheduling the personal shopper he will be taken to the screen (18) which shows the delivery time, delivery address and additional costs for delivery. Further proceeds to payment summary page followed by payment methods page for making payment and for pacing the order (20)

When above order is placed successfully in Samyata. Nearby Personal Shoppers will receive notifications regarding the new order.

Below Flow shows Personal Shopper Application Flow:

When a personal shopper get notified regarding the new order. He can see the same order under new orders tab in screen (ps1). Clicking on the new order id takes the personal shopper to order details screen (PS1) where he could see the details like Store Location, Shopper Location and Delivery Date etc based on which personal shopper can choose to accept the order or not. In this scenario once Personal shopper accepts the order, the same order moves from open orders to the accepted orders screen (PS2). Once Personal shopper accepts the order he goes to the store to pick the product. For picking the product personal shopper needs to show the QR code to the store and get it scanned. QR code will be revealed only when Personal Shopper rates the store screen (PS3) once personal shopper rates the store QR Code will be revealed screen (PS4) personal shopper shows the QR code to the store and get it scanned to receive the product. Store people will scan the QR code using scanner features in Samyata Store application and handover the product only if both the QR code matches with one another. Once personal shopper picks the product from the store same order will be moved from Accepted to Picked up orders (PS5) clicking on order id under picked up orders takes the personal shopper to order details page where he can see the shopper location map (PS6). Personal shopper goes to the shopper and scan the QR code under picked order (PS7) with the shopper's QR code. Personal shopper needs to rate the shopper and shopper need to rate the personal shopper for completing the scanning process. Personal shopper delivers the product to the shopper only when the QR code matches with the shopper's QR code (PS9). When both the QR code matches order will be delivered to the shopper and get moved from picked up orders to closed orders screen (PS10)

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more specific purpose computers and/or computer systems, networked and/or otherwise. Where applicable, the ordering of various steps described herein may be changed, combined into composite steps, and/or separated into sub-steps to provide features described herein.

The various features and steps described herein may be implemented as systems comprising one or more memories storing various information described herein and one or more processors coupled to the one or more memories and a network, wherein the one or more processors are operable to perform steps as described herein, as non-transitory machine-readable medium comprising a plurality of machine-readable instructions which, when executed by one or more processors, are adapted to cause the one or more processors to perform a method comprising of steps described herein, and methods performed by one or more devices, such as a hardware processor, mobile device, server, and other devices described herein.

The foregoing disclosure is not intended to limit the present disclosure to the precise forms or particular fields of use disclosed. As such, it is contemplated that various alternative embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method comprising a common platform for bringing stores, shoppers and personal shoppers in a geographically specific locations having three independent applications performing combinedly to achieve a unique shopping experience through online shopping portal or mobile application, wherein the system works on unique elements in the application with,
Algorithm for product search;
Algorithm for assignment of personal shoppers in product delivery results, which personal shoppers get displayed as having a product for a shopper;
The auto-rotate bar for product images;
Samyata Now;
Samyata Gives;
Samyata Loyalty;
Samyata Conversational UI;
Your own Personal Shopping Network
and further comprising,
UI Layer,
Application Layer,
Data Layer, and
API Layer
to perform all the desired functions of the application for an online shopping to integrate stores, shoppers and personal shoppers in a geographically specific location.

2. A method as claimed in claim 1, wherein the operation further comprises a shopper logs into Samyata web application or mobile phone app, which will be opened to signup screen to give his mobile contact number and to proceed with signup so that the application server will send an OTP message to the users mobile phone which has to be entered in the next screen and submit verification of the OTP entered; the system will take the user to the next screen where he is required to set login password, after submit will take to the home screen to start the shopping experience.

3. A method as claimed in claim 1, wherein the operation further comprises in the next screen (1), shopper has a search option to search his desired product to buy; and when the user clicks the search button in the screen (1), another next screen (1) will be opened with the search results (1), where the user can select the product and click to enter into next screen (2) where it shows complete description of the product, its reviews, rating given by previous users and with an option in this screen (2) to click to Buy it.

4. A method as claimed in claim 1, wherein the operation further comprises when the user clicks Buy it button, the screen (3) will be opened showing the geographical map of the area where the stores in which the product is available and user can also see the distance between the stores and location from where he accesses.

5. A method as claimed in claim 1, wherein the operation further comprises in this screen (4), the user is given a button to click to see the list of stores as per geographical location in the previous screen; enters into the next screen (4) and in this screen (4) it shows the store rating, store product price and stock availability by which the user can take the decision to go with any one of the stores in that geographical location; upon selecting a store in screen (4) any specific store to purchase.

6. A method as claimed in claim 1, wherein the operation further comprises the next screen (5) opens showing the delivery methods options like of pick-up from the store or delivery by a personal shopper; the user has to select the option in screen (5) to proceed to the next screen (6) showing the payment summary and proceed to the next screen (7) to select the payment method and make the payment in the next screen (8) through their selected payment method; the application takes to the next screen (10) showing the order placed, taking the application to the next screen (11) to rate the store to reveal the QR code and further screen (15) shows the closed orders;

7. A method as claimed in claim 1, wherein the operation further comprises that the Samyata application has a specific further experience where the user in screen (16) after selecting the delivery method by the personal shopper option, the screen moves and opens another screen (17) to schedule a personal shopper selection button; also in this screen (17) shows the delivery time, delivery address and additional costs for delivery and also shopper gets to enter how much he is willing to pay for the delivery and also get to choose his favorite personal shopper to make the delivering entering all the details takes the shopper to payment summary as per screen (18) to proceed to screen (19) for payment method and closing the orders.

8. A method as claimed in claim 1, when a personal shopper get notified regarding the new order. He can see the same order under new orders tab in screen (ps1). Clicking on the new order id takes the personal shopper to order details screen (PS1) where he could see the details like Store Location, Shopper Location and Delivery Date etc based on which personal shopper can choose to accept the order or not. In this scenario once Personal shopper accepts the order, the same order moves from open orders to the accepted orders screen (PS2). Once Personal shopper accepts the order he goes to the store to pick the product. For picking the product personal shopper needs to show the QR code to the store and get it scanned. QR code will be revealed only when Personal Shopper rates the store screen (PS3) once personal shopper rates the store QR Code will be revealed screen (PS4) personal shopper shows the QR code to the store and get it scanned to receive the product. Store people will scan the QR code using scanner features in Samyata Store application and handover the product only if both the QR code matches with one another. Once personal shopper picks the product from the store same order will be moved from Accepted to Picked up orders (PS5) clicking on order id under picked up orders takes the personal shopper to order details page where he can see the shopper location map (PS6). Personal shopper goes to the shopper and scan the QR code under picked order (PS7) with the shopper's QR code. Personal shopper needs to rate the shopper and shopper need to rate the personal shopper for completing the scanning process. Personal shopper delivers the product to the shopper only when the QR code matches with the shopper's QR code (PS9). When both the QR code matches order will be delivered to the shopper and get moved from picked up orders to closed orders screen (PS10)
